(19) United States
(12) Patent Application Publication
(10) Pub. No.: US 2026/0340447 A1
(43) Pub. Date: Oct. 29, 2026

(54) INFORMATION PROCESSING PROGRAM, METHOD, AND APPARATUS

(71) Applicant: Fujitsu Limited, Kawasaki-shi (JP)

(72) Inventor: Takuya TAKAGI, Kawasaki (JP)

(73) Assignee: Fujitsu Limited, Kawasaki-shi (JP)

(21) Appl. No.: 19/702,656

(22) Filed: Jun. 9, 2026

Related U.S. Application Data
(63) Continuation of application No. PCT/JP2023/044283, filed on Dec. 11, 2023.

(51) Int. Cl. G06N 5/025

(52) U.S. Cl. CPC G06N 5/025

(57) ABSTRACT

An information processing apparatus includes a processor that executes a procedure. The procedure includes: selecting at least one determination rule from a plurality of determination rules, each including at least one condition and a label for data corresponding to the at least one condition, so as to maximize a value of an objective function based on interpretability and determination accuracy of the determination rule, and extracting a first rule list; generating at least one candidate rule list by adding a candidate determination rule for addition selected from the plurality of determination rules to a candidate set in a case in which a value of an objective function for the candidate rule list including the determination rules in the candidate set increases in a case in which the candidate determination rule for addition is added to the candidate set, and not adding the candidate determination rule for addition or a determination rule including the at least one condition included in the candidate determination rule for addition to the candidate set in a case in which the value of the objective function does not increase; and outputting the candidate rule list, and outputting the first rule list in which a difference between a value of an objective function for the first rule list and the value of the objective function for the candidate rule list is equal to or less than a predetermined threshold.

### CROSS-REFERENCE TO RELATED APPLICATION

This application is a continuation application of International Application No. PCT/JP 2023/044283, filed Dec. 11, 2023, the disclosure of which is incorporated herein by reference in its entirely.

### FIELD

The present disclosure relates to an information processing program, an information processing method, and an information processing apparatus.

### BACKGROUND

Hitherto, a determination rule for constructing a rule-based determination model is extracted from a plurality of determination rules. For example, an apparatus that searches for a rule having a high evaluation value or a low evaluation value by depth-first search from a plurality of rules having a hierarchical relationship has been proposed. The apparatus searches for candidate rules from a plurality of rules having a tree structure relationship (hierarchical relationship) in which child rules (lower-level rules) and sibling rules (same-level rules) are arranged according to the order of condition items, in an order reverse to the order of condition items used in a case in which constructing the tree structure. Then, the apparatus compares evaluation values of the rules in the order of search, and outputs a rule with a higher evaluation value.

Furthermore, for example, there has been proposed an information processing apparatus that represents a plurality of determination rules each including one or more conditions, and executes the following processing in order from an upper vertex of tree structure data having the conditions included in each determination rules as vertices as an evaluation target. The apparatus evaluates an objective function for a determination rule set in a case in which a determination rule including a condition corresponding to a vertex to be evaluated is added to the determination rule set to be extracted. Then, in a case in which evaluation indicated by the objective function monotonously decreases, the apparatus excludes, from the evaluation target, a determination rule including a condition corresponding to the vertex to be evaluated and a vertex lower than the vertex to be evaluated.

### CITED LITERATURE

### Patent Literature

Patent Literature 1: Japanese Patent Application Laid-Open No. 2005-38073

Patent Literature 2: International Publication No. 2023/188411

### SUMMARY

According to an aspect of the embodiments, selecting at least one determination rule from a plurality of determination rules, each including at least one condition and a label for data corresponding to the at least one condition, so as to maximize a value of an objective function based on interpretability and determination accuracy of the determination rule, and extracting a first rule list; generating at least one candidate rule list by adding a candidate determination rule for addition selected from the plurality of determination rules to a candidate set in a case in which a value of an objective function for the candidate rule list including the determination rules in the candidate set increases in a case in which the candidate determination rule for addition is added to the candidate set, and not adding the candidate determination rule for addition or a determination rule including the at least one condition included in the candidate determination rule for addition to the candidate set in a case in which the value of the objective function does not increase; and outputting the candidate rule list, and outputting the first rule list in which a difference between a value of an objective function for the first rule list and the value of the objective function for the candidate rule list is equal to or less than a predetermined threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of an information processing apparatus according to the present embodiment.

FIG. 2 is a diagram illustrating an example of a dataset.

FIG. 3 is a diagram for describing a determination rule.

FIG. 4 is a diagram illustrating an example of a determination model.

FIG. 5 is a diagram for describing a case in which all possible combinations of features are set as candidates for a condition part.

FIG. 6 is a diagram illustrating an example of an enumeration tree.

FIG. 7 is a diagram for describing the number of correct answers and the number of incorrect answers.

FIG. 8 is a diagram for describing an example of generation of enumeration tree candidates.

FIG. 9 is a diagram illustrating an example of a plurality of enumeration tree candidates.

FIG. 10 is a diagram illustrating an example of outputs of a plurality of determination models.

FIG. 11 is a block diagram illustrating a schematic configuration of a computer that functions as the information processing apparatus.

FIG. 12 is a flowchart illustrating an example of an information processing routine.

FIG. 13 is a flowchart illustrating an example of enumeration tree candidate generation processing.

### DESCRIPTION OF EMBODIMENTS

Hereinafter, an example of an embodiment according to the disclosed technology will be described with reference to the drawings.

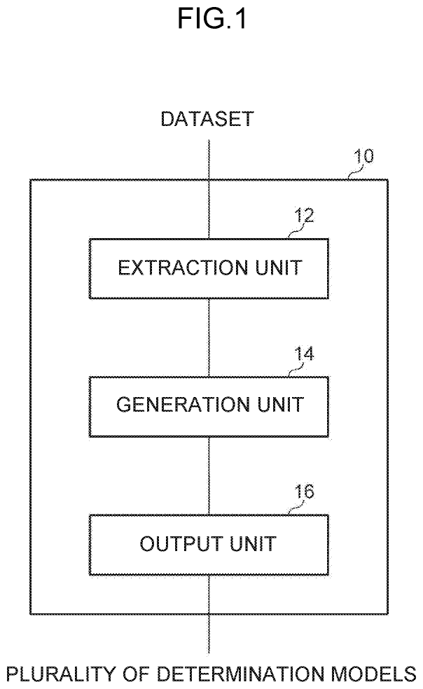

As illustrated in FIG. 1, a dataset is input to an information processing apparatus 10 according to the present embodiment. The information processing apparatus 10 extracts determination rules for constructing a rule-based determination model from the input dataset, and outputs the determination rules as a plurality of rule lists.

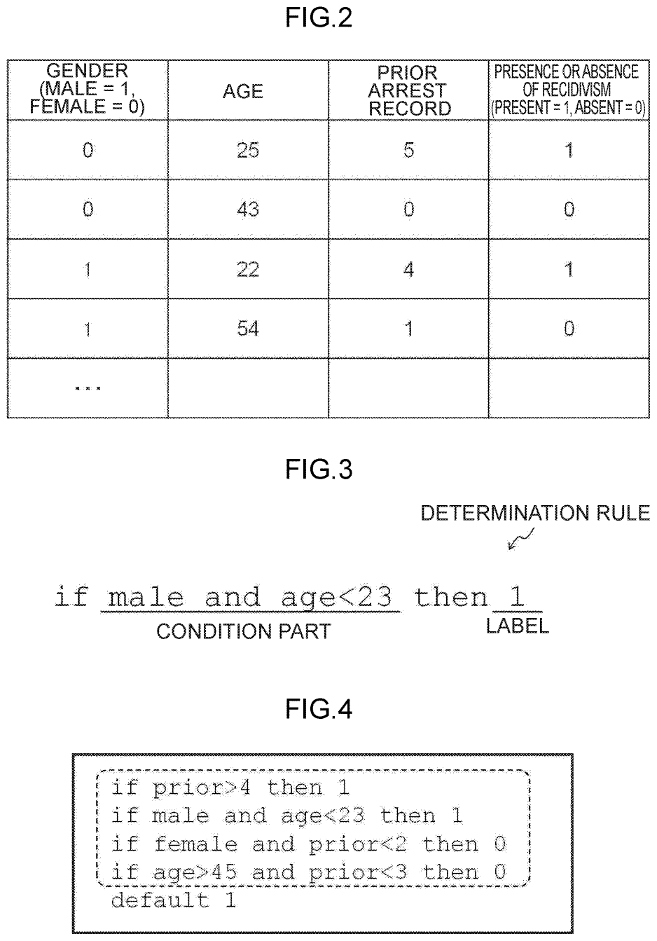

The dataset includes a plurality of pieces of data in which at least one feature and a label are associated with each other. FIG. 2 illustrates an example of the dataset. In the example of FIG. 2, each row (each record) is one piece of data, and an item “gender” and a value thereof, an item “age” and a value thereof, and a “prior arrest record” and a value thereof are features, respectively. In addition, the “presence or absence of recidivism” is a label.

The rule-based determination model is a model expressed by the rule list, which is a set of the determination rules in a form of “if A then B” (if A, the prediction is B), and a rule definition. As illustrated in FIG. 3, in the determination rule, part A is referred to as a “condition part”, and part B is referred to as a “label”. That is, a determination rule r is a pair (s,c)∈U×C of a condition part s and a label c. U and C are described below.

The condition part s is a combination of one or more features among features included in the dataset. Specifically, in a case in which a power set of all the features X={x₁,x₂, . . . , x_{M}} (M is the total number of features) included in the dataset is U, the condition part s is s∈U. In the present embodiment, the condition part s is a logical product of combinations of the features. For example, the condition part s including a combination of the first feature x₁, the fourth feature x₄, and the fifth feature x₅ is x₁\hat{ }x₄\hat{ }x₅. As described above, the feature is a combination of an item included in the dataset and a value thereof, such as “gender =1 (male)”. In a case in which the value of the item is a numerical value, a value obtained by discretizing the numerical value may be used, or the feature may be represented using an inequality sign like “age>40”.

The label c represents a predicted value into which data satisfying the condition indicated by the condition part is classified, and in a case in which a set of labels is C, the label c is c∈C. For example, in a case in which the presence or absence of recidivism is predicted from data such as the dataset illustrated in FIG. 2, any one in the set of labels C={1 (present),0 (absent)} indicating the presence or absence of recidivism is set as the label c, similarly to the label of the dataset. The label c of the determination rule r does not need to be the same as the label of the dataset. For example, in a case in which the labels included in the dataset are E, F, and G, the label may be set to “1” in a case in which the predicted value is E, and the label may be set to “2” in a case in which the predicted value is F or G.

FIG. 4 illustrates an example of the determination model. In the example of FIG. 4, a broken line portion indicates the rule list, and the other portion indicates the rule definition. In a case in which data to be determined satisfies the condition indicated by the condition part of the determination rule, the determination model acquires the label of the determination rule as the predicted value, and outputs a determination result for the data to be determined on the basis of the predicted value based on each determination rule and the rule definition. For example, in a case in which it is defined as the rule definition that the determination result is determined by a majority vote of the predicted values based on the respective determination rules, the determination model outputs, as the determination result, the most frequent predicted value (“0 ” or “1” in the example of FIG. 4) among the predicted values based on the respective determination rules. In FIG. 4, “default 1” is an example of the rule definition, and indicates that in a case in which the data to be determined does not satisfy the condition indicated by the condition part of any determination rule included in the rule list, the label “1” is output as the determination result.

Here, in the case of constructing a model with guaranteed optimality and high interpretability as the determination model, the rule list needs to satisfy both a condition (1) that a small number of and short determination rules are included, and a condition (2) that accuracy in prediction using each determination rule is high. The above conditions (1) and (2) are in a trade-off relationship. Therefore, it is desirable to construct the determination model that yields the optimal value (hereinafter, referred to as an “objective function value”) obtained by evaluating the rule list by an objective function integrated according to an importance ratio between the conditions (1) and (2).

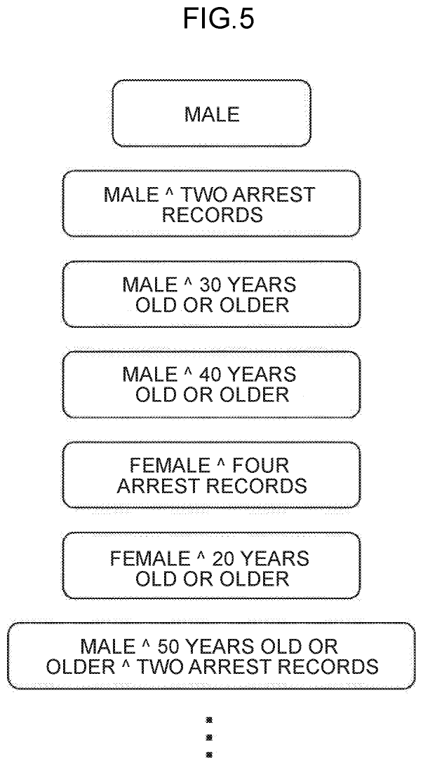

Therefore, as illustrated in FIG. 5, it is conceivable to set all the possible combinations of the features as candidates of the condition part on the basis of the dataset, extract an optimal condition part by evaluating all the candidates of the condition part, and set a set of determination rules including the extracted condition part as the rule list. In this case, all the condition parts are evaluated, so that it is possible to construct an optimal determination model satisfying the above conditions (1) and (2). However, since the number of all the condition parts, that is, the number of all the combinations of the features is 2ⁿ-1 in a case in which the number of features is n, a combinatorial explosion occurs in a case in which the number of features is large. For example, in a case in which the number of features is 30, about 1 billion condition parts exist, and in a case in which the number of features is 50, about 1000 trillion condition parts exist, as a result of which it is impossible to evaluate all the condition parts within a realistic time frame. In addition, since there are a plurality of condition parts having a low degree of contribution to the actual determination among all the condition parts, an unnecessary processing load is generated in a case in which considering such condition parts.

Furthermore, in a case in which a plurality of rule lists are output, it is necessary to exhaustively repeat processing of extracting one optimal rule list, excluding the rule list, and then extracting the next optimal rule list, which increases a computational cost.

Therefore, the information processing apparatus 10 according to the present embodiment calculates a determination rule including an overwhelmingly small number of condition parts with respect to the total number of possible condition parts at a high speed without missing the condition parts included in the rule list representing an optimal solution. Furthermore, the information processing apparatus 10 constructs the rule list of the objective function values in which a difference from the objective function value obtained by evaluating the rule list representing the optimal solution is equal to or less than a predetermined value ε, thereby outputting a plurality of rule lists that are approximate solutions to the optimal solution. Hereinafter, the information processing apparatus 10 according to the present embodiment will be described in detail.

The information processing apparatus 10 functionally includes an extraction unit 12, a generation unit 14, and an output unit 16 as illustrated in FIG. 1.

The extraction unit 12 acquires the dataset input to the information processing apparatus 10. The extraction unit 12 selects at least one determination rule so as to maximize the objective function value based on the interpretability and the determination accuracy of the determination rule among the plurality of determination rules comprehensively generated from the dataset, and extracts a first rule list (optimal rule list). For example, a related art such as the method of Patent Literature 2 may be applied to the extraction of the optimal rule list by the extraction unit 12.

In the present embodiment, the determination rule r including the extracted condition part s is extracted by extracting the condition part s from U such that the objective function value indicating that (1) a small number of and short determination rules are included, and (2) accuracy in prediction using each determination rule is high is optimized. In the present embodiment, the following four scores are defined as indices that increase as the rule list including the extracted determination rule r is a better rule list, the sum of the scores is set as the objective function value, and a rule list having the maximum objective function value is extracted.
1. A score that increases as the number of determination rules included in the rule list decreases
2. A score that increases as the length of the determination rule included in rule list decreases
3. A score that increases as the number of pieces of data for which prediction by the determination rule is correct increases
4. A score that increases as the number of pieces of data for which prediction by the determination rule is incorrect decreases

The generation unit 14 calculates the objective function value for a candidate rule list including determination rules in a candidate set in a case in which a candidate determination rule for addition selected from the plurality of determination rules based on the dataset input to the information processing apparatus 10 is added to the candidate set. In a case in which the objective function value increases, the generation unit 14 adds the candidate determination rule for addition to the candidate set. On the other hand, in a case in which the objective function value does not increase, the generation unit 14 does not add the candidate determination rule for addition or a determination rule including a determination part included in the candidate determination rule for addition to the candidate set. Then, the generation unit 14 generates the candidate rule list from the determination rules in the candidate set.

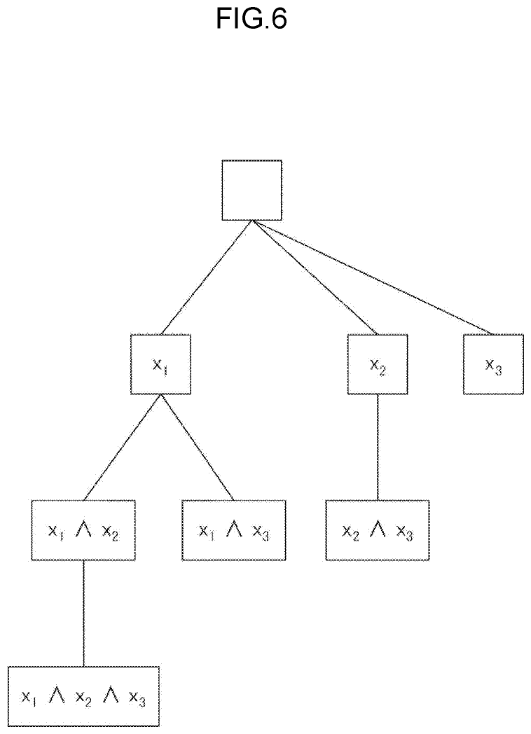

Specifically, the generation unit 14 generates an enumeration tree having each condition part included in the determination rule as a vertex. As illustrated in FIG. 6, in the enumeration tree, a condition part corresponding to each vertex is a condition part obtained by adding one feature to a condition part corresponding to a parent vertex of the corresponding vertex. In FIG. 6, X={x₁,x₂,x₃}, and a rectangle represents each vertex, and a character string in the rectangle represents a condition part corresponding to the vertex. A vertex with a blank inside the rectangle is a vertex serving as a root, that is, a vertex having no parent vertex.

More specifically, the generation unit 14 determines whether or not an objective function value for an enumeration tree candidate increases in a case in which a candidate vertex for addition is added to the enumeration tree candidate in the order of depth-first search with respect to the vertex serving as the root. In a case in which the objective function value increases, the generation unit 14 adds the candidate vertex for addition to the enumeration tree candidate. On the other hand, in a case in which the objective function value does not increase, the generation unit 14 does not add the candidate vertex for addition and vertices that are descendants of the candidate vertex for addition to the enumeration tree candidate. The generation unit 14 generates a plurality of enumeration tree candidates by making combinations of the vertices to be added to the enumeration tree candidates different from each other.

For example, the generation unit 14 calculates an increment B of the objective function value in a case in which the candidate vertex for addition is added to the enumeration tree by, for example, the following Formula (1).

B=−λ_{size}−λₗₑₙ·|length of determination rule|−λ_{prec}·|number of incorrect answers|+λ_{recall}·|number of correct answers| (1)

−λ_{size} represents a penalty for adding one candidate vertex for addition to the enumeration tree candidate. −λₗₑₙ·|length of determination rule| represents a penalty proportional to the length of the determination rule corresponding to the added vertex. The length of the determination rule is the number of features included in the condition part of the determination rule. −λ_{prec}·|number of incorrect answers| represents a penalty proportional to the number of pieces of data for which prediction is incorrect according to the determination rule corresponding to the added vertex. +λ_{recall}·|number of correct answers| represents a reward proportional to the number of pieces of data for which prediction is correct according to the determination rule corresponding to the added vertex. In addition, each of λ_{size}, λₗₑₙ, λ_{prec}, and λ_{recall} is a parameter representing the degree of importance of each term. The degree of importance may be a predetermined value or may be received from the user.

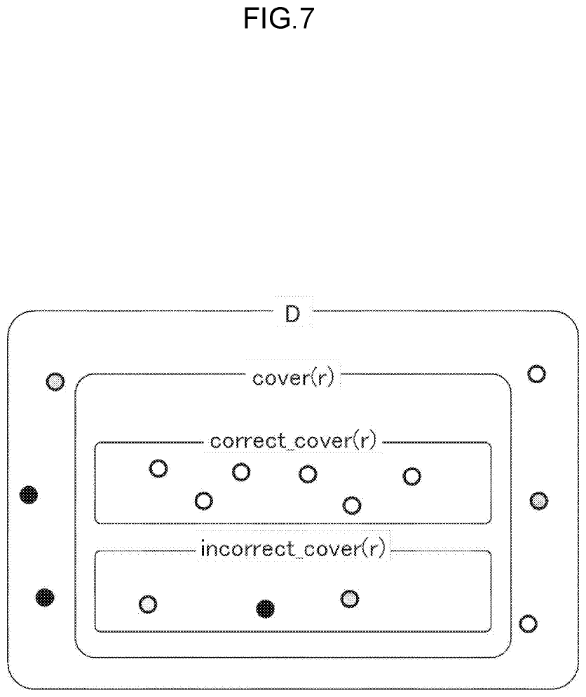

The number of correct answers corresponds to the number of pieces of data included in “correct_cover(r)” illustrated in FIG. 7, and the number of incorrect answers corresponds to the number of pieces of data included in “incorrect_cover(r)” illustrated in FIG. 7. In FIG. 7, D represents a set of all pieces of data included in the dataset, and cover(r) represents a set of pieces of data satisfying the condition part s of the determination rule r=(s, c) corresponding to the candidate vertex for addition. In addition, in FIG. 7, a circle corresponds to each piece of data, and a difference in color (density) in the circle represents a difference in label of the data. Assuming that a specific label to be determined in the determination model is y, a label of data corresponding to a white circle is y, and labels of pieces of data corresponding to a shaded circle and a black circle are other than y. Therefore, each piece of data is set as a pair (x, c) of the feature x and the label c, and correct_cover(r)={(x,y)∈cover(r)|c=y} is satisfied in a case in which the specific label is y. Further, incorrect_cover(r) =cover(r)\correct_cover(r).

In addition, the generation unit 14 calculates B′ in the following Formula (2) as an evaluation value that satisfies monotonicity that decreases as the length of the determination rule to be added to the rule list increases.

B′=−λ_{size}−λₗₑₙ·|length of determination rule|+λ_{recall}·|number of correct answers| (2)

B′ is obtained by removing the penalty of −λ_{prec}·|number of incorrect answers| from the increment B of the objective function value in Formula (1). Since B′ has a penalty reduced by one from B, B′≥B always holds. Therefore, B′ can be estimated as the upper bound of the increment of the objective function value, that is, the maximum value of the increment B of the objective function value in a case in which the determination rule to be evaluated is added to the rule list. In other words, B′ is an increment of the objective function value in a case in which it is assumed that performance of the determination model constructed by the rule list is improved most significantly by adding the determination rule to be evaluated to the rule list.

The longer the length of the determination rule, the smaller the range (“cover(r)” in FIG. 7) covering the condition part of the determination rule. Therefore, in a case in which the length of the determination rule increases, the number of incorrect answers decreases, but the number of correct answers also decreases, and in Formula (2), −λₗₑₙ·|length of determination rule| increases, and +λ_{recall}·|number of correct answers| decreases. That is, B′ has monotonicity that continues to decrease as the length of the determination rule increases. Therefore, a negative value of B′ for a certain determination rule to be evaluated indicates that the objective function value is never improved even in a case in which a longer determination rule is added to the rule list. Therefore, it is not necessary to add a determination rule longer than the determination rule to the rule list.

In a case in which the objective function value monotonously decreases, the generation unit 14 excludes the candidate vertex for addition and a vertex at a lower level than the candidate vertex for addition from candidates for addition. Further, in a case in which the objective function value increases, the generation unit 14 adds the candidate vertex for addition to the enumeration tree candidate.

Specifically, for the candidate vertex for addition, in a case in which the upper bound B′ of the increment is 0 or less, the generation unit 14 prunes the candidate vertex for addition and the vertices that are descendants of the candidate vertex for addition from the enumeration tree candidate, thereby excluding the vertices from the candidates for addition. In addition, for a vertex that has not been excluded from the candidates for addition, in a case in which the increment B of the objective function value is a positive value, the generation unit 14 adds the vertex to the enumeration tree candidate.

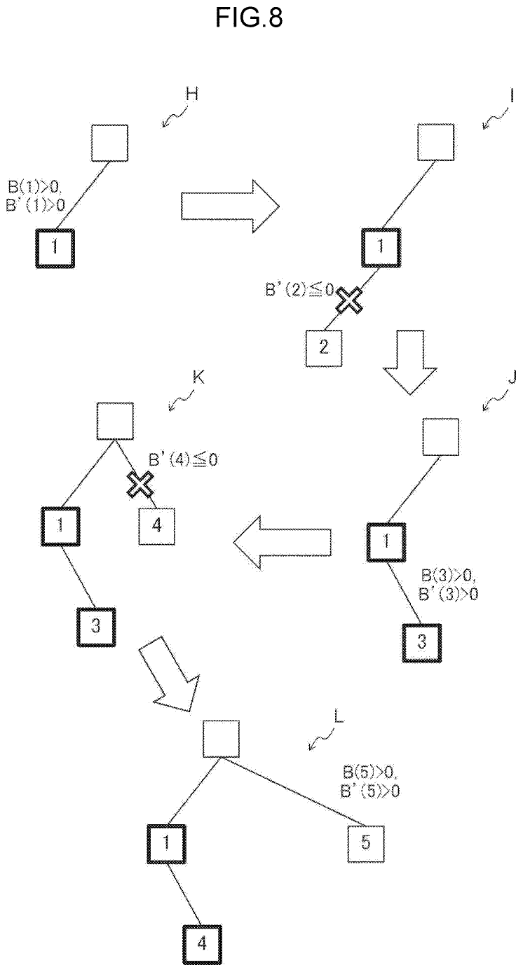

An example of generation of the enumeration tree candidate will be described with reference to FIG. 8. In the example of FIG. 8, the order of search from the vertex serving as the root by the depth-first search is indicated in each vertex. In addition, an increment of the objective function value for the i-th vertex (hereinafter, referred to as “vertex i”) in the order of the depth-first search is denoted as B(i), and an upper bound of the increment is denoted as B′(i).

The generation unit 14 sets a vertex 1 as the candidate for addition as a child vertex of the vertex serving as the root, and determines whether or not to add the vertex 1 on the basis of an increment B(1) of the objective function value and an upper bound B′(1) of the increment. Here, when B(1)>0 and B′(1)>0, the vertex 1 is added to the enumeration tree candidate (H in FIG. 8). Next, the generation unit 14 sets the vertex 2, which is a child vertex of the vertex 1, as the candidate for addition. Here, when B′(2) ≤0, since the vertex 2 is a target for pruning, the generation unit 14 does not add the vertex 2 and vertices that are descendants of the vertex 2 to the enumeration candidates (I in FIG. 8). Next, the generation unit 14 sets a vertex 3, which is a child vertex of the vertex 1, as the candidate for addition. Here, when B(3)>0 and B′(3)>0, the vertex 3 is added to the enumeration tree candidate (J in FIG. 8).

Next, in a case in which there is no child vertex of the vertex 3, the generation unit 14 sets a vertex 4, which is a child vertex of the vertex serving as the root, as the candidate for addition. Here, when B′(4)≤0, since the vertex 4 is a target for pruning, the generation unit 14 does not add the vertex 4 and vertices that are descendants of the vertex 4 to the enumeration candidates (K in FIG. 8). Next, the generation unit 14 sets a vertex 5, which is a child vertex of the vertex serving as the root, as the candidate for addition. Here, when B(5)>0 and B′(5)>0, the vertex 5 is added to the enumeration tree candidate (L in FIG. 8). As described above, by pruning the vertices that do not increase the objective function value, it is not necessary to determine whether or not to add the vertices that are descendants to the enumeration tree candidate, so that a processing load in generating the enumeration tree candidate is reduced.

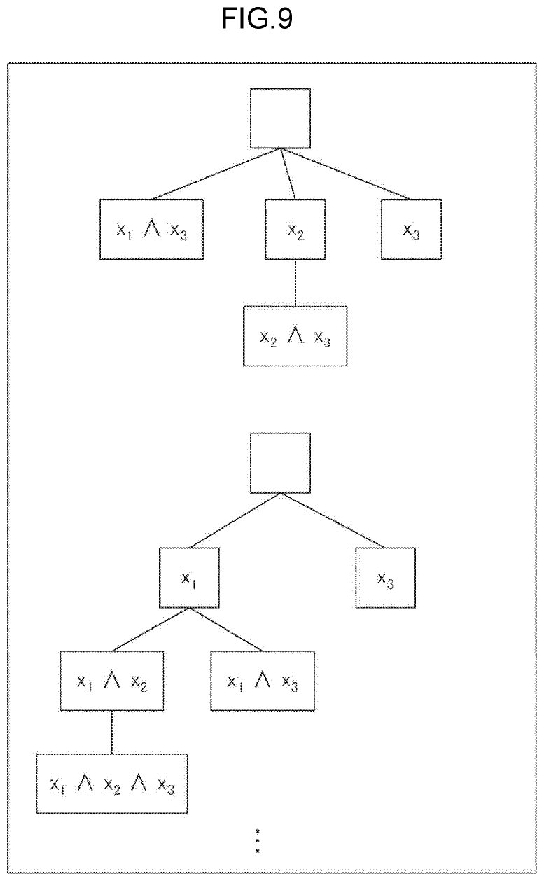

The form of the enumeration tree candidate changes depending on which determination rule a vertex corresponding thereto is added for. Therefore, for example, the generation unit 14 generates a plurality of enumeration tree candidates as illustrated in FIG. 9, for example, by setting vertices corresponding to different determination rules as the first candidate vertices (H in FIG. 8) for addition for the vertex serving as the root.

The output unit 16 outputs the candidate rule list and the optimal solution of the rule list in which a difference between the objective function value for the optimal solution of the rule list and the objective function value for the candidate rule list is equal to or less than a predetermined threshold ε.

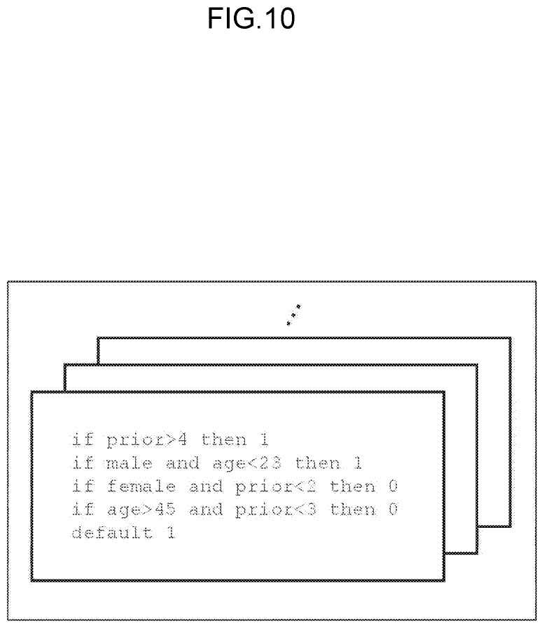

Specifically, for each of the enumeration tree candidates generated by the generation unit 14, the output unit 16 calculates an objective function value g, which is the sum of the above-described four scores, for a set of the determination rules corresponding to the respective vertices included in the enumeration tree candidate. In a case in which a difference between an objective function value f calculated at the time of calculating the rule list of the optimal solution by the extraction unit 12 and the objective function value g of the enumeration tree candidate is equal to or less than ε, the output unit 16 generates the rule lists of the approximate solutions to the optimal solution from the enumeration tree candidate. The output unit 16 constructs the determination model by assigning the rule definition to the rule list of the optimal solution and each of the rule lists of the approximate solutions, and outputs a plurality of determination models as illustrated in FIG. 10.

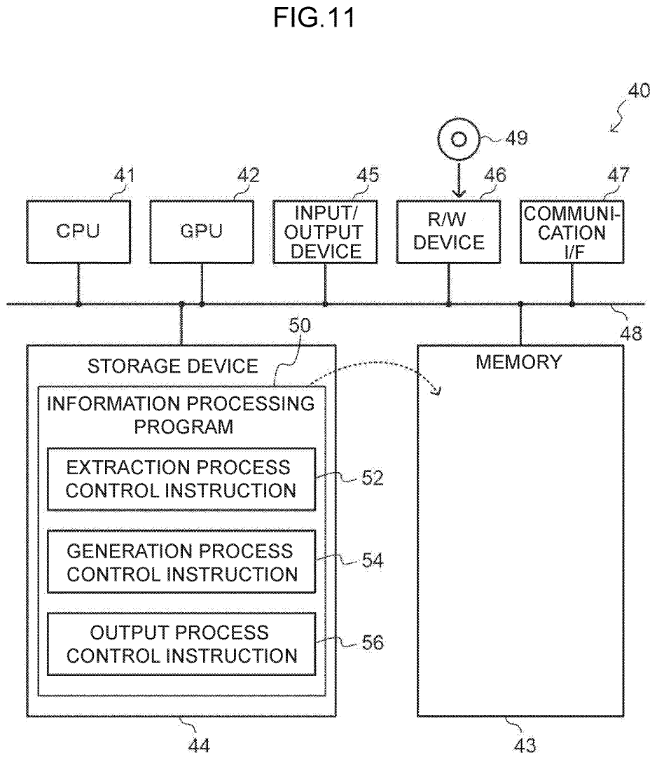

The information processing apparatus 10 may be implemented by, for example, a computer 40 illustrated in FIG. 11. The computer 40 includes a central processing unit (CPU) 41, a graphics processing unit (GPU) 42, a memory 43 serving as a temporary storage area, and a nonvolatile storage device 44. In addition, the computer 40 includes an input/output device 45 such as an input device and a display device, and a read/write (R/W) device 46 that controls reading and writing of data with respect to a storage medium 49. The computer 40 further includes a communication interface (I/F) 47 connected to a network such as the Internet. The CPU 41, the GPU 42, the memory 43, the storage device 44, the input/output device 45, the R/W device 46, and the communication I/F 47 are connected to each other via a bus 48.

The storage device 44 is, for example, a hard disk drive (HDD), a solid state drive (SSD), or a flash memory. The storage device 44 serving as a storage medium stores an information processing program 50 for causing the computer 40 to function as the information processing apparatus 10. The information processing program 50 includes an extraction process control instruction 52, a generation process control instruction 54, and an output process control instruction 56.

The CPU 41 reads the information processing program 50 from the storage device 44, loads the program onto the memory 43, and sequentially executes the control instructions included in the information processing program 50. The CPU 41 operates as the extraction unit 12 illustrated in FIG. 1 by executing the extraction process control instruction 52. The CPU 41 operates as the generation unit 14 illustrated in FIG. 1 by executing the generation process control instruction 54. The CPU 41 operates as the output unit 16 illustrated in FIG. 1 by executing the output process control instruction 56. As a result, the computer 40 executing the information processing program 50 functions as the information processing apparatus 10. The CPU 41 that executes the program is hardware. Furthermore, a part of the program may be executed by the GPU 42.

The functions implemented by the information processing program 50 may be implemented by, for example, a semiconductor integrated circuit, more specifically, an application specific integrated circuit (ASIC), a field-programmable gate array (FPGA), or the like.

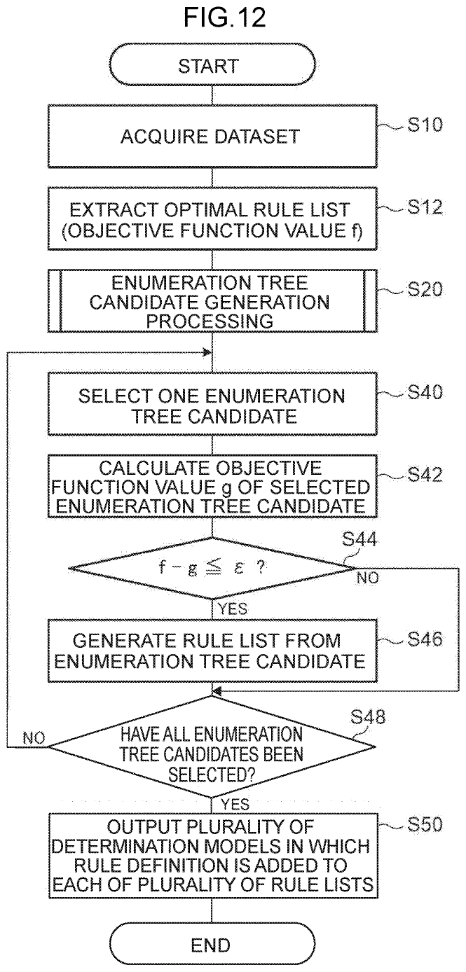

Next, an operation of the information processing apparatus 10 according to the present embodiment will be described. When the dataset is input to the information processing apparatus 10 and output of a plurality of determination programs is instructed, the information processing apparatus 10 executes an information processing routine illustrated in FIG. 12. The information processing routine is an example of an information processing method of the disclosed technology.

In step S10, the extraction unit 12 acquires the dataset input to the information processing apparatus 10. Next, in step S12, the extraction unit 12 selects at least one determination rule so as to maximize the objective function value based on the interpretability and the determination accuracy of the determination rule among the plurality of determination rules based on the dataset, and extracts an optimal rule list. The objective function value obtained by evaluating the optimal rule list is f.

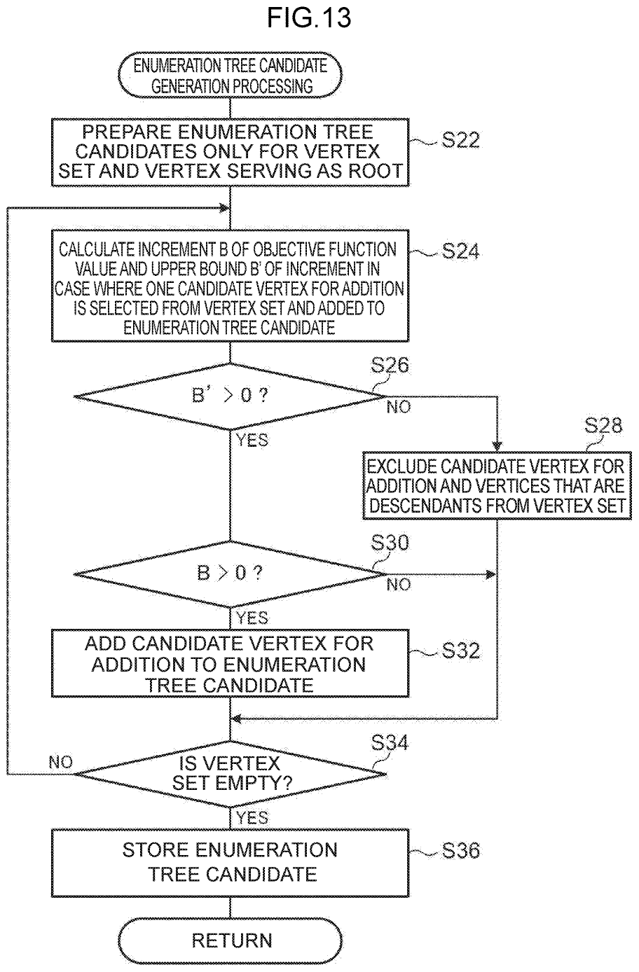

Next, in step S20, enumeration tree candidate generation processing is executed. Here, enumeration tree candidate generation processing will be described with reference to FIG. 13.

In step S22, the generation unit 14 prepares a vertex set storing vertices corresponding to the condition parts included in the plurality of determination rules based on the dataset, and the enumeration tree candidates only for the vertex serving as the root. Next, in step S24, the generation unit 14 selects one vertex as the candidate for addition in the order of a depth search direction from the vertex set, and calculates the increment B of the objective function value and the upper bound B′ of the increment in a case in which the candidate vertex for addition is added to the enumeration tree candidate.

Next, in step S26, the generation unit 14 determines whether or not the upper bound B′ of the increment of the objective function value is larger than 0. In a case in which B′>0, the processing proceeds to step S30, and in a case in which B′≤0, the processing proceeds to step S28. In step S28, the generation unit 14 excludes the candidate vertex for addition and vertices that are descendants of the candidate vertex for addition from the vertex set, and proceeds to step S34.

In step S30, the generation unit 14 determines whether or not the increment B of the objective function is larger than 0. In a case in which B>0, the processing proceeds to step S32, and in a case in which B≤0, the processing proceeds to step S34. In step S32, the generation unit 14 adds the candidate vertex for addition to the enumeration tree candidate. Next, in step S34, the generation unit 14 determines whether or not the vertex set is empty. In a case in which the vertex set is empty, the processing proceeds to step S36, and in a case in which there remains an unprocessed vertex in the vertex set, the processing proceeds to step S24.

In step S36, the generation unit 14 stores the generated enumeration tree candidate in a predetermined storage area, and the enumeration tree candidate generation processing ends. The generation unit 14 generates a plurality of enumeration tree candidates by setting vertices corresponding to different determination rules as vertices to be first selected as the candidates for addition in step S24 and executing the enumeration tree candidate generation processing illustrated in FIG. 13, and returns to the information processing routine (FIG. 12).

Next, in step S40, the output unit 16 selects one enumeration tree candidate generated in step S20. Next, in step S42, the output unit 16 calculates the objective function value g of the selected enumeration tree candidate. Next, in step S44, the output unit 16 calculates the difference f-g between the objective function value f of the optimal rule list calculated in step S12 and the objective function value g of the enumeration tree candidate calculated in step S42. Then, the output unit 16 determines whether or not the difference f-g is equal to or less than the threshold ε. In a case in which f−g≤ε, the processing proceeds to step S46, and in a case in which f−g>ε, the processing proceeds to step S48.

In step S46, the output unit 16 generates the rule list from the enumeration tree candidate. Next, in step S48, the output unit 16 determines whether or not all the enumeration tree candidates have been selected. In a case in which there is an unselected enumeration tree candidate, the processing returns to step S40, and in a case in which all the enumeration tree candidates have been selected, the processing proceeds to step S50.

In step S50, the output unit 16 constructs and outputs a plurality of determination models in which the rule definition is added to the optimal rule list extracted in step S12 and each of the plurality of rule lists generated in step S46. Then, the information processing routine ends.

As described above, the information processing apparatus according to the present embodiment selects at least one determination rule so as to maximize the objective function value based on the interpretability and the determination accuracy of the determination rule among the plurality of determination rules based on the dataset, and extracts an optimal rule list. In addition, the information processing apparatus determines whether or not the objective function value for the candidate rule list including the determination rules in the candidate set increases in a case in which the candidate determination rule for addition selected from the plurality of determination rules is added to the candidate set. The information processing apparatus adds the candidate determination rule for addition to the candidate set in a case in which the objective function value increases, and does not add the candidate determination rule for addition or a determination rule including at least one condition included in the candidate determination rule for addition to the candidate set in a case in which the objective function value does not increase. Then, the information processing apparatus executes processing of generating the candidate rule list from the determination rules included in the candidate set a plurality of times to generate a plurality of candidate rule lists. Further, the information processing apparatus outputs the candidate rule list and the optimal rule list in which a difference between the objective function value for the optimal rule list and the objective function value for the candidate rule list is equal to or less than a predetermined threshold. As a result, with the information processing apparatus according to the present embodiment, it is possible to output the optimal solution of the rule list and the rule lists of the approximate solutions in which a difference in objective function from the optimal solution is at most ε without evaluating all the rule lists. That is, it is possible to reduce the computational cost for enumerating the plurality of rule lists that can ensure both the determination accuracy and the interpretability.

In the above embodiment, a case in which four scores are included as the increment B of the objective function has been described as an example, but the disclosed technology is not limited thereto. It is sufficient if a score that can set B′ that is always larger than the increment B and has monotonicity that continues to decrease as the length of the determination rule to be added increases is used. For example, B and B′ obtained by removing at least one of −λ_{size} and +λ_{recall}·|number of correct answers| from Formulas (1) and (2) may be used.

In the above embodiment, the information processing program is stored (installed) in the storage device in advance, but the disclosed technology is not limited thereto. The program according to the disclosed technology may be provided in the form of being stored in a storage medium such as a CD-ROM, a DVD-ROM, or a USB memory.

In the construction of the rule-based determination model, in order to ensure both determination accuracy by the determination model and interpretability for a determination result, it is necessary to extract a determination rule that enables high-accuracy determination with as few and as short determination rules as possible. In the related art, it is possible to extract a rule list that is a determination rule set representing an optimal solution and maximizes a value of the objective function for extracting the determination rule as described above.

However, there is a possibility of missing useful information only by providing a user with one rule list representing the optimal solution. In addition, there may be a case in which new knowledge is found by enumerating and observing rule lists other than the optimal rule list. In this regard, it is assumed that a plurality of rule lists capable of ensuring both determination accuracy and interpretability are enumerated.

However, in this case, processing of extracting one optimal rule list, excluding the rule list, and then extracting the next optimal rule list needs to be repeated exhaustively, and there is a problem in that a computational cost for enumerating a plurality of rule lists increases.

As one aspect, an effect that it is possible to reduce a computational cost for enumerating a plurality of rule lists that can ensure both determination accuracy and interpretability can be obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

10 Information processing apparatus
12 Extraction unit
14 Generation unit
16 Output unit
40 Computer
41 CPU
42 GPU
43 Memory
44 Storage device
45 Input/output device
46 R/W device
47 Communication I/F
48 Bus
49 Storage medium
50 Information processing program
52 Extraction process control instruction
54 Generation process control instruction
56 Output process control instruction

1. A non-transitory recording medium storing a program executable by a computer to perform information processing comprising:
selecting at least one determination rule from a plurality of determination rules, each including at least one condition and a label for data corresponding to the at least one condition, so as to maximize a value of an objective function based on interpretability and determination accuracy of the determination rule, and extracting a first rule list;
generating at least one candidate rule list by adding a candidate determination rule for addition selected from the plurality of determination rules to a candidate set in a case in which a value of an objective function for the candidate rule list including the determination rules in the candidate set increases in a case in which the candidate determination rule for addition is added to the candidate set, and not adding the candidate determination rule for addition or a determination rule including the at least one condition included in the candidate determination rule for addition to the candidate set in a case in which the value of the objective function does not increase; and
outputting the candidate rule list, and outputting the first rule list in which a difference between a value of an objective function for the first rule list and the value of the objective function for the candidate rule list is equal to or less than a predetermined threshold.

2. The information processing program of claim 1, wherein:
the objective function includes a first term for decreasing the value of the objective function as a length of the condition included in the determination rule increases, and a second term for decreasing the value of the objective function as a number of incorrect answers satisfying the condition of the determination rule increases, and
it is determined that the value of the objective function increases in a case in which a value obtained by excluding the second term from the objective function is larger than 0.

3. The information processing program of claim 2, wherein the objective function further includes a third term for decreasing the value of the objective function as the number of determination rules included in the candidate set increases, and a fourth term for increasing the value of the objective function as a number of correct answers satisfying the condition of the determination rule increases.

4. The information processing program of claim 1, wherein a plurality of enumeration tree candidates are generated by adding a candidate vertex for addition to an enumeration tree candidate, which is an enumeration tree candidate having each of the determination rules included in the candidate set as a vertex, and in which the vertices are connected in a parent-child relationship based on an inclusion relationship of the condition of the determination rule corresponding to the vertex; by this, adding the candidate vertex for addition to the enumeration tree candidate in a case in which a value of an objective function for the enumeration tree candidate increases, and not adding the candidate vertex for addition or vertices that are descendants of the candidate vertex for addition to the enumeration tree candidate in a case in which the value of the objective function does not increase; and by this, making combinations of the vertices to be added to the enumeration tree candidate different from each other.

5. An information processing method, comprising:
by a processor,
selecting at least one determination rule from a plurality of determination rules, each including at least one condition and a label for data corresponding to the at least one condition, so as to maximize a value of an objective function based on interpretability and determination accuracy of the determination rule, and extracting a first rule list;
generating at least one candidate rule list by adding a candidate determination rule for addition selected from the plurality of determination rules to a candidate set in a case in which a value of an objective function for the candidate rule list including the determination rules in the candidate set increases in a case in which the candidate determination rule for addition is added to the candidate set, and not adding the candidate determination rule for addition or a determination rule including the at least one condition included in the candidate determination rule for addition to the candidate set in a case in which the value of the objective function does not increase; and
outputting the candidate rule list, and outputting the first rule list in which a difference between a value of an objective function for the first rule list and the value of the objective function for the candidate rule list is equal to or less than a predetermined threshold.

6. The information processing method of claim 5, wherein:
the objective function includes a first term for decreasing the value of the objective function as a length of the condition included in the determination rule increases, and a second term for decreasing the value of the objective function as a number of incorrect answers satisfying the condition of the determination rule increases, and
it is determined that the value of the objective function increases in a case in which a value obtained by excluding the second term from the objective function is larger than 0.

7. The information processing method of claim 6, wherein the objective function further includes a third term for decreasing the value of the objective function as the number of determination rules included in the candidate set increases, and a fourth term for increasing the value of the objective function as a number of correct answers satisfying the condition of the determination rule increases.

8. The information processing method of claim 5, wherein a plurality of enumeration tree candidates are generated by adding a candidate vertex for addition to an enumeration tree candidate, which is an enumeration tree candidate having each of the determination rules included in the candidate set as a vertex, and in which the vertices are connected in a parent-child relationship based on an inclusion relationship of the condition of the determination rule corresponding to the vertex; by this, adding the candidate vertex for addition to the enumeration tree candidate in a case in which a value of an objective function for the enumeration tree candidate increases, and not adding the candidate vertex for addition or vertices that are descendants of the candidate vertex for addition to the enumeration tree candidate in a case in which the value of the objective function does not increase; and by this, making combinations of the vertices to be added to the enumeration tree candidate different from each other.

9. An information processing apparatus, comprising:
a memory; and
a processor coupled to the memory, the processor being configured to execute processing including:
selecting at least one determination rule from a plurality of determination rules, each including at least one condition and a label for data corresponding to the at least one condition, so as to maximize a value of an objective function based on interpretability and determination accuracy of the determination rule, and extracting a first rule list;
generating at least one candidate rule list by adding a candidate determination rule for addition selected from the plurality of determination rules to a candidate set in a case in which a value of an objective function for the candidate rule list including the determination rules in the candidate set increases in a case in which the candidate determination rule for addition is added to the candidate set, and not adding the candidate determination rule for addition or a determination rule including the at least one condition included in the candidate determination rule for addition to the candidate set in a case in which the value of the objective function does not increase; and
outputting the candidate rule list, and outputting the first rule list in which a difference between a value of an objective function for the first rule list and the value of the objective function for the candidate rule list is equal to or less than a predetermined threshold.

10. The information processing apparatus of claim 9, wherein:
the objective function includes a first term for decreasing the value of the objective function as a length of the condition included in the determination rule increases, and a second term for decreasing the value of the objective function as a number of incorrect answers satisfying the condition of the determination rule increases, and
it is determined that the value of the objective function increases in a case in which a value obtained by excluding the second term from the objective function is larger than 0.

11. The information processing apparatus of claim 10, wherein the objective function further includes a third term for decreasing the value of the objective function as the number of determination rules included in the candidate set increases, and a fourth term for increasing the value of the objective function as a number of correct answers satisfying the condition of the determination rule increases.

12. The information processing apparatus of claim 9, wherein a plurality of enumeration tree candidates are generated by adding a candidate vertex for addition to an enumeration tree candidate, which is an enumeration tree candidate having each of the determination rules included in the candidate set as a vertex, and in which the vertices are connected in a parent-child relationship based on an inclusion relationship of the condition of the determination rule corresponding to the vertex; by this, adding the candidate vertex for addition to the enumeration tree candidate in a case in which a value of an objective function for the enumeration tree candidate increases, and not adding the candidate vertex for addition or vertices that are descendants of the candidate vertex for addition to the enumeration tree candidate in a case in which the value of the objective function does not increase; and by this, making combinations of the vertices to be added to the enumeration tree candidate different from each other.
